(19) United States
(12) Patent Application Publication
(10) Pub. No.: US 2013/0060667 A1
(43) Pub. Date: Mar. 7, 2013

(54) ENERGY MANAGEMENT MODELING LANGUAGE

(71) Applicant: Robert James Burke, Dallas, TX (US)

(72) Inventor: Robert James Burke, Dallas, TX (US)

(21) Appl. No.: 13/223,632

(22) Filed: Sep. 1, 2011

(51) Int. Cl. G06Q 50/06; G06Q 10/00; G06F 3/048; G06Q 30/04

(52) U.S. Cl. 705/34; 715/771

(57) ABSTRACT

A system, computer-implemented method, and a computer program product are provided for an energy management modeling language. Selections of a location, a time, a first variable identifier, a second variable identifier, a third variable identifier, and text that specifies a transform based on an energy management modeling language primitive are received via a user interface. The first variable identifier, the second variable identifier, and the third variable identifier are reformatted based on the location and the time. The transform is executed based on the reformatted first variable and the reformatted second variable to create a result. The result is output based on the reformatted third variable.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### FIELD OF THE PRESENT DISCLOSURE

The embodiments of the present disclosure relate generally to energy management, and more specifically to a system, computer-implemented method, and computer program product for an energy management modeling language.

### BACKGROUND

Energy management systems are complex systems that aggregate information from multiple sub-systems in a customer's facility to provide insight into the customer's energy consumption. Unfortunately, many energy management systems are so highly specialized that they do not provide any actionable information based on the customer's business intelligence layer. A customer may require an energy management system that integrates the customer's Facility Domain seamlessly into the customer's Energy Domain, and finally into the customer's Business Domain.

As used herein, Facility Domain refers to the one or more facility, building, plant, operations platform, etc., consuming energy, and the power uses within such facilities, and expertise specific related to such facility, such as knowledge regarding building management, physical assets, power use, energy power consumption devices, and monitoring tools. A customer will have personnel, whether employees or contractors, with expertise in the Facility Domain, and capable of defining or identifying facility Performance Indicators, referred to as a Facility Manager.

As used herein, Energy Domain refers to energy consumption, use, distribution of use, energy consumption behavior, energy measurement, energy use measurement, key Performance Indicators for a business sector, etc., and the knowledge and expertise specific to such information. A customer will have personnel, whether employees or contractors, with expertise in the Energy Domain and capable of defining or identifying energy use Performance Indicators.

As used herein, Business Domain refers to business or customer operations, revenue, revenue targets, budgeting, planning, costs, cost goals, etc., and the knowledge and expertise relevant to the business. A customer will have personnel, whether employees or contractors, with expertise in the Business Domain capable of defining or identifying business Performance Indicators.

Energy Resource Management, as used herein, refers to management of energy consumption and its by-products at the Business Domain level.

Business Intelligence as used herein refers to software-based tools used to extract, create, and/or import key Performance Indicators for the business.

Performance Indicators, as used herein, refers to data or variables regarding energy consumption, energy resource management, costs, usage, budgets, temperature data, goals, metered data, etc., that can be used to generate insights into energy consumption or costs. Performance Indicators are also referred to herein as Domain Variables.

Domain Mapping, as used herein, refers to the translation of Performance Indicators from one domain to a set of Performance Indicators in another domain. For example, a business Performance Indicator may be a number of sales per kilowatt hour, while a Facility Manager may only be interested in the average temperature during the same period of sales.

The development and use of relevant Performance Indicators for an energy management system may require tightly integrated participation by a customer in the development process, necessitating a level of software maturity that many software vendors lack. After a long and costly period of trial and error, the customer may turn instead to identifying and hiring an expensive expert to develop the required Performance Indicators using the customer's energy management system because many energy management systems are often highly specialized and very complex. However, the hired expert may encounter many challenges in mapping the customer's Business Domain to the customer's Energy Domain, or from the customer's Energy Domain to the customer's Business Domain, because such mapping is often non-intuitive, difficult, and highly technical. Subsequently, the development of such Performance Indicators is often expensive, complex, time-consuming, error prone, and incorrectly representative of the domain mappings. Although many energy management systems may effectively provide run-time data, alerts, and alarms, energy management systems typically provide energy analytics and energy intelligence of limited usefulness. The time and expense of a full software development life cycle is required for the development of each Performance Indicator, such that a customer may not be able to quickly or easily engage in experimenting with new Performance Indicators. Furthermore, operational and computational challenges may arise for large quantities of required Performance Indicators. The scalability of an energy management system required for large numbers of Performance Indicators creates serious usability issues.

### SUMMARY

A system, computer-implemented method, and computer program product are provided for an energy management modeling language, which provide capabilities to customers that contrast with challenges created by software vendors who lack the software maturity to sufficiently integrate a customer into the process of developing Performance Indicators and hired experts who incorrectly map a customer's Business Domain to the customer's Energy Domain. An energy management modeling language provides customers with the capability of quickly and easily identifying and using variables from mutually exclusive domains to create and/or test Performance Indicators without the need to engage a software vendor or a hired expert and without the wait required for a lengthy software development life cycle.

A customer can easily select a facility location, a time frame, and various variables from simple menus provided by a single display screen even if the variables are from mutually exclusive databases. For example, the system receives the customer selections of a thermostat from a Facility Domain, a total cost from the Energy Domain, a budget from the Business Domain, and a time period of a month. The user interface displays the selections in a succinct manner to enable the customer to review the selections and enter simple text that specifies a transform, which may be an equation, based on an energy management modeling language primitive. For example, the system receives the customer's entry of text that includes simple if-then statements and the name of the variables for the total cost and the budget.

The system reformats the variable identifiers based on the location and the time. For example, the system converts the total cost to the total monthly cost for the facility and converts the budget to the monthly budget for the facility, thereby ensuring variable compatibility. The system executes the transform based on the reformatted variables to create a result. For example, the system compares the total monthly cost for the facility to the monthly budget for the facility based on the if-then statements entered by the customer. The system outputs a result based on at least one reformatted variable. For example, if the system determines that an if-then statement that compares the total monthly cost to the facility to the monthly budget for the facility is true, then the system outputs a control command to the thermostat in the basement of the facility to take an action specified by the customer's text entry. A customer may achieve operational scalability by drastically reducing the development life cycle to create and/or test a large number of Performance Indicators through the elimination of middlemen such as software vendors and hired experts during a greatly accelerated development process.

### BRIEF DESCRIPTION OF THE DRAWINGS

Drawings of the preferred embodiments of the present disclosure are attached hereto so that the embodiments of the present disclosure may be better and more fully understood:

FIG. 1 presents a sample system of the present disclosure;

FIG. 2 presents a sample frame depicted by a user interface of the present disclosure;

FIG. 3 presents a sample method of the present disclosure.

### DETAILED DESCRIPTION OF SOME EMBODIMENTS

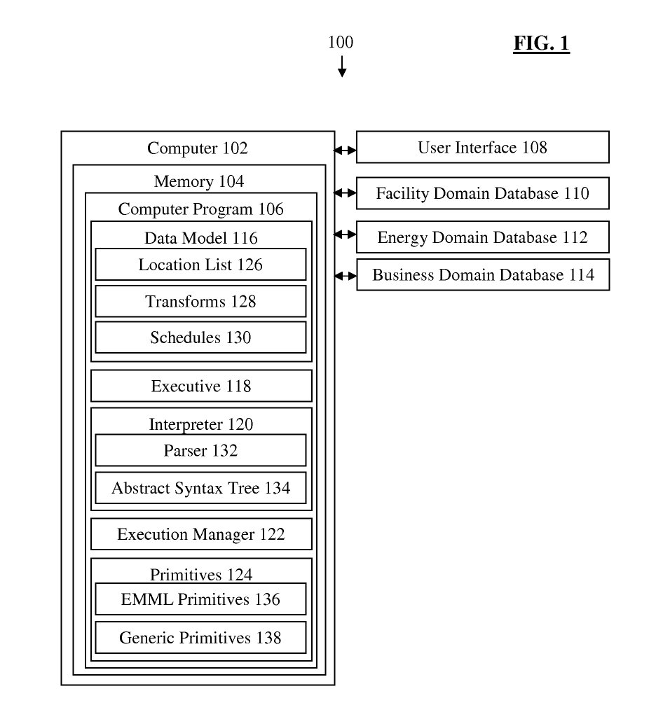

FIG. 1 presents a sample system 100 of the present disclosure, which may also be referred to as an energy management system 100. The system 100 includes a computer 102, a memory 104, a computer program 106, and a user interface 108. The computer program 106 is stored in the memory 104 and executed by the computer 102 to communicate via the user interface 108 with system users.

The computer 102 also communicates with a Facility Domain database 110, an Energy Domain database 112, and a Business Domain database 114, which may be mutually exclusive databases. The computer program 106 includes a data model 116, an executive 118, an interpreter 120, an execution manager 122, and primitives 124. The data model 116 includes a location list 126, transforms 128, and schedules 130. The interpreter 120 includes a parser 132 and an abstract syntax tree 134. The primitives 124 include energy management modeling language (EMML) primitives 136 and generic primitives 138. Although FIG. 1 depicts one of each of the elements 102-138, the system 100 may include any number of each of the elements 102-138.

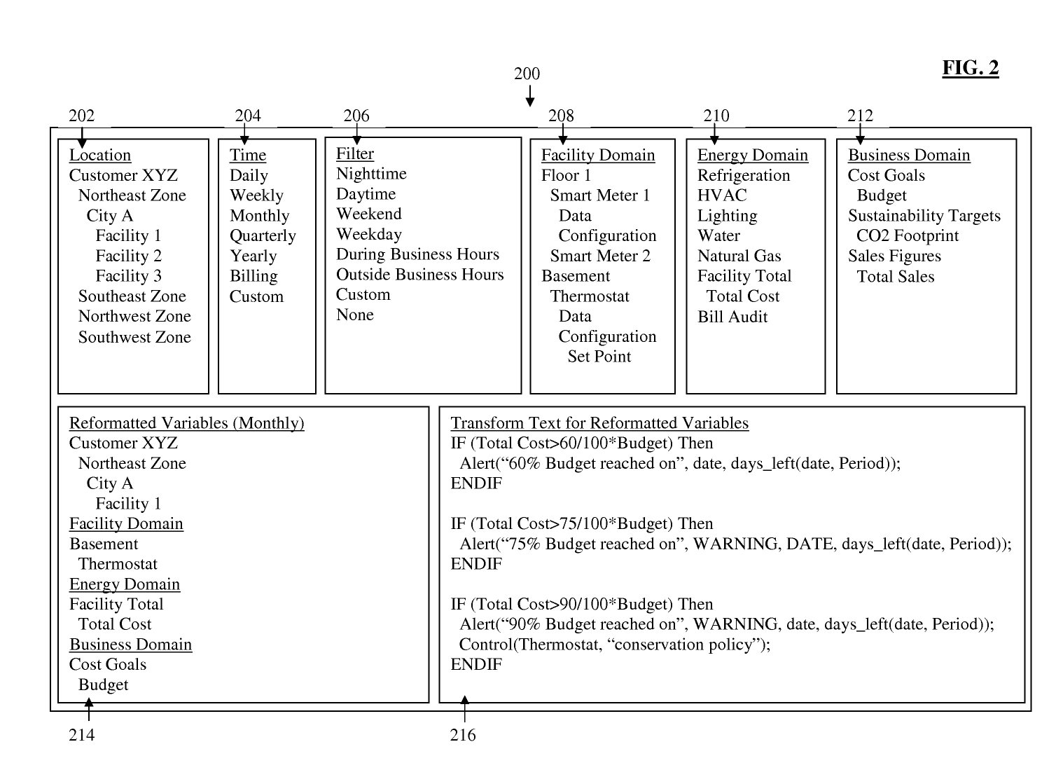

The data model 116 includes the locations list 126 that identifies the locations of specified data in the databases 110-114, the transforms 128 associated with the specified data, and the schedules for applying the transforms 128. The executive 118 scans data in the databases 110-114, and loads the transforms 128 that are associated with locations in the databases 110-114 and are to be applied according to the schedules 130. The interpreter 120 includes a parser 132 that parses the transforms 128 conveyed by the executive 118 to build the abstract syntax tree 134. The execution manager 122 combines the abstract syntax tree 134 built by the interpreter 120 with the primitives 124 and executes the combination. The primitives 124 include EMML primitives 136 and generic primitives 138 used by the execution manager 120 to convert the abstract syntax tree 134 to an executable format. Examples of EMML primitives 136 are discussed below in reference to FIG. 2. Examples of generic primitives 138 include a variable assignment, such as “=”, a mathematical operator, such as “+”, a mathematical operator precedence specifier, such as “( )”, a logical operator such as “>”, and a flow control instruction, such as an if-then statement.

Examples of data or Performance Indicators in the Business Domain include budgets, corporate energy conservation goals, sales transactions, operational expenses, energy cost, demand cost, transaction and energy cost. Examples of data or Performance Indicators in the Energy Domain, upon which data in the Business Domain may be based, include calculated data such as real usage, reactive usage, power factor, maximum demand, kilovolt-ampere reactive (kVAr), kilovolt-ampere reactive hours (kVArh), power factor, kilowatts during a base time of use, kilowatts during an intermediate time of use, kilowatts during a sub-peak time of use, kilowatts during a peak time of use, kilowatt hours during a base time of use, kilowatt hours during an intermediate time of use, kilowatt-hours during a sub-peak time of use, and kilowatt hours during a peak time of use. Examples of data or Performance Indicators in the Facility Domain, upon which the data in the Energy Domain may be based, include raw data such as meter data, meter configuration, real-time data, a sampling frequency, heating ventilation and air conditioning (HVAC) data, lighting data, humidity and, temperature.

The system 100 provides capabilities to customers that contrast with challenges created by software vendors who lack the software maturity to sufficiently integrate a customer into the process of developing Performance Indicators and hired experts who incorrectly map a customer's Business Domain to the customer's Energy Domain. An energy management modeling language provides customers with the capability of quickly and easily identifying and using variables from mutually exclusive domains to create and/or test Performance Indicators without the need to engage a software vendor or a hired expert and without the wait required for a lengthy software development life cycle.

A customer can easily select a facility location, a time frame, and various Domain Variables from simple menus provided by a single display screen via the user interface 108, even if the variables are from mutually exclusive databases, such as the domain databases 110-114. For example, the computer program 106 receives the customer selections of a thermostat, a total cost, a budget, and a time period of a month. The user interface 108 displays the selections in a succinct manner, such as depicted below in the reformatted variables column 214 in FIG. 2, to enable the customer to review the selections and enter text that specifies a transform, which may be an equation, based on an energy management modeling language primitive, such as depicted below in the transforms text for reformatted variables column 216 in FIG. 2. For example, the computer program 106 receives the customer's entry of text that includes simple if-them statements and the name of the variables for the total cost and the budget.

A transform is a mathematical relationship defined using the supported EMML primitives 136 and/or the generic primitives 138. The computer program 106 may use transforms 128 to create mathematical results which may be persisted throughout the system 100 as a global variable. For example, if the computer program 106 uses temperature and humidity data to calculate a facility's thermostat set point based on text entered by a customer, the computer program 106 may make the calculated set point available for access by the customer as a global variable that other transforms 128 may apply to other facilities. The computer program 106 may use transforms 128 to create a trigger for a prescribed set of actions, which may change the state of a managed system, such as a facility. For example, the computer program 106 may output a control command to initiate a conservative policy via a facility's thermostat.

The executive 118 uses the location list 126 to scan the domain databases 110-114 to identify Domain variables with which transforms 128 have been associated. Upon identifying such a variable and its associated transform, the executive 118 dispatches the interpreter 120 to reformat the variable for execution with its associated transform if the schedules 130 indicate that this action is or should be currently scheduled. The interpreter may compare the current time to the previous run time and the schedules 130 to determine whether the required action should be currently scheduled.

The executive 118 dispatches the interpreter 120 to reformat the variable identifiers based on the location and the time. For example, the executive 118 dispatches the interpreter 120, which converts the total cost to the total monthly cost for the facility and converts the budget to the monthly budget for the facility. The interpreter 120 may reformat selected variables in many other ways to ensure variable compatibility for variables from the mutually exclusive domain databases 110-114. The interpreter 120 parses a transform provided by the executive 118 using both the EMML primitive 136 and the generic primitives 138 to build the abstract syntax tree 134 that corresponds to the provided transform.

The execution manager 122 executes the transform based on the reformatted variables to create a result. For example, the execution manager 122 combines the abstract syntax tree 134 with the selected variables to compare the total monthly cost for the facility to the monthly budget for the facility based on the if-then statements entered by the customer. A result may be the outcome of a mathematical calculation, such as a thermostat set point, or a Boolean-based action, such as a control command to initiate a conservative policy via a thermostat based on the computer program 106 evaluating a condition as true. The computer program 106 outputs a result based on at least one reformatted variable. For example, if the execution manager 122 determines that an if-then statement that compares the total monthly cost to the facility to the monthly budget for the facility is true, then the computer program 106 outputs a control command to the thermostat in the basement of the facility to take an action specified by the customer's text entry. A customer may achieve operational scalability by drastically reducing the development life cycle to create and/or test a large number of Performance Indicators through the elimination of middlemen such as software vendors and hired experts during a greatly accelerated development process.

FIG. 2 presents a sample frame 200 presented by the user interface 108 in FIG. 1 of the present disclosure. The frame 200 includes various Performance Indicators in a location column 202, a time column 204, a filter column 206, a facility domain column 208, an energy domain column 210, a business domain column 212, a reformatted variables column 214, and a transform text for reformatted variables column 216.

The location column 202 includes a row for customer XYZ, which includes indented rows for a northeast zone, a southeast zone, a northwest zone, and a southwest zone. If the indented row for the northeast zone is selected via the user interface 108, the location column 202 depicts a double indented row for the city A. If the double indented row for the city A is selected via the user interface 108, the location column 202 depicts triple indented rows for facility 1, facility 2, and facility 3. If the triple indented row for facility 1 is selected via the user interface 108, the computer program 106 receives this selection of the facility 1 location. Subsequent selections of variable identifiers may be based on the location selection. For example, the computer program 106 receives the selection of the triple indented row for facility 1 in the location column 202, presents variables that correspond to facility 1 in city A in the northeast zone for selection in the columns 208-212, and identifies this location selection in the reformatted variables column 214.

The time column 204 includes rows for daily, weekly, monthly, quarterly, yearly, billing, and custom. For example, since the computer program 106 receives the selection of the row for monthly in the time column 204, the computer program 106 reformats the variables selected from the columns 208-212 to reflect a monthly value for each of the selected variables, and identifies this time selection in the heading of the reformatted variables column 214.

The filter column 206 includes rows for nighttime, daytime, weekend, weekday, during business hours, outside business hours, custom, and none. For example, since the computer program 106 receives the selection of the row for “none” in the filter column 206, the computer program 106 has no need for the additional reformatting of the variables selected from the columns 208-212 to reflect a monthly value for each of the selected variables. However, if the computer program 106 receives a selection of one of the other filter options, the computer program 106 reformats the variables selected from the columns 208-212 based on the selected filter, such as reformatting the total monthly cost for facility 1 to the total monthly weekday cost for facility 1.

The Facility Domain column 208 includes rows for floor 1 and basement, which correspond to facility 1 selected from the location column 202. If the row for floor 1 was selected via the user interface 108, the Facility Domain column 208 may depict indented rows for smart meter 1 and smart meter 2. If the indented row for smart meter 1 was selected via the user interface 108, the Facility Domain column 208 may depict double indented rows for data and configuration. If the row for the basement of facility 1 is selected via the user interface 108, the Facility Domain column 208 depicts a double indented row for a thermostat. If the double indented row for the thermostat of facility 1 was selected via the user interface 108, the Facility Domain column 208 may depict triple indented row for data and configuration of the thermostat. If the triple indented row for the configuration of the thermostat was selected via the user interface 108, the Facility Domain column 208 may depict a quadruple indented row for the set point of the thermostat. In this example, since the computer program 106 receives the selection of the double indented row for the thermostat in the Facility Domain column 208, the computer program 106 identifies this selection in the reformatted variables column 214.

The Energy Domain column 210 includes rows for refrigeration, HVAC (heating, ventilation, and air conditioning), lighting, water, natural gas, facility total, and bill audit. If the row for facility total is selected via the user interface 108, the Energy Domain column 210 depicts an indented row for total cost. In this example, since the computer program 106 receives the selection of the indented row for total cost in the Energy Domain column 210, the computer program 106 identifies this selection in the reformatted variables column 214.

The Business Domain column 212 includes rows for cost goals, sustainability targets, and sales figures. If the row for sustainability targets was selected via the user interface 108, the Business Domain column 212 may depict an indented row for CO2 footprint. If the row for sales figures was selected via the user interface 108, the Business Domain column 212 may depict an indented row for total sales. If the row for cost goals is selected via the user interface 108, the Business Domain column 212 depicts an indented row for budget. In this example, since the computer program 106 receives the selection of the indented row for budget in the Business Domain column 212, the computer program 106 identifies this selection in the reformatted variables column 214.

The reformatted variables column 214 includes references to previous selections. For example, the reformatted variables column 214 depicts the selection of facility 1 in city A in the northeast zone for customer XYZ as the location selection, the thermostat in the basement of facility 1 as the variable selected from the Facility Domain, the total cost of the facility total for facility 1 as the variable selected from the Energy Domain, and the budget of the cost goals for facility 1 as the variable selected from the Business Domain. The heading for the reformatted variable column 214 includes the notation “(Monthly)” to indicate the selection of the row for monthly in the time column 204. Similarly, the heading for the reformatted variable column 214 would also include a notation to indicate the selection of any option other than the row for “none” from the filter column 206.

The transform text for reformatted variables column 216 includes text entered by a customer via the user interface 108. Complicated computer programs are typically written in computer languages by either software vendors or hired experts, and typically require a lengthy software development life cycle before the computer program is laboriously compiled into executable language that may have to wait before it can be loaded into a live data system. In contrast, this customer-entered text is based on a few simple primitives that the customer can easily understand, and text which may be interpreted and executed quickly by a live data system without the need for compilation or the need to wait before the text can be used by the live data system.

The text in the column 216 consists of the EMML primitives 136 and the generic primitives 138 of FIG. 1 and the reformatted variables that are clearly and succinctly identified for a customer in the reformatted variables column 214. The simple if-then statements entered by the customer provide for corresponding alerts to be output when the total monthly cost for facility 1 exceeds 60%, 75%, and 90% of the monthly budget for facility 1. The last if-then statement entered by the customer provides a control command which is output to the thermostat in the basement of facility 1 when the total monthly cost for facility 1 exceeds 90% of the monthly budget for facility 1. The control command is an example of an EMML primitive 136 that illustrates the bi-directional nature of the computer program 106 in traversing the Facility Domain, the Energy Domain and the Business Domain. The computer program 106 can not only input variables from each of these mutually exclusive domains 110-114, but can also output commands, pre-existing variables, and newly created variables to each of these mutually exclusive domains 110-114. The computer program 106 may input data associated with the thermostat in the basement of facility 1, such as the thermostat's current set point and any operating schedule for the thermostat, and may also output a control command to the thermostat in the Facility Domain based on a comparison of a variable from the Energy Domain to a variable from the Business Domain.

Examples of other EMML primitives include an organizational asset tree that groups facility assets into at least one set; an aggregate primitive that accumulates data over a period of the time; a billing primitive such as a time of use period, a peak demand, a usage cost, a billable demand, and a demand cost; a persistence primitive that stores a variable for subsequent use by another transform; a domain variable that specifies the location, the time, and a variable identifier; an action primitive to prescribe a function based on a transform, such as an action primitive that is an alert, a log, and/or a control command.

An example of an organizational asset tree that groups facility assets into at least one set is depicted in the location column 202, in which facilities are grouped geographically. Examples of aggregate primitives that accumulate data over a period of time include total daily cost, total weekly cost, total monthly cost, total quarterly cost, and total yearly cost for a facility. An example of a persistence primitive that stores a variable for subsequent use by another transform is a calculated set point for a thermostat in facility 1, which may be used as a calculated set point that is output to other thermostats in other facilities based on whether the computer program 106 evaluates other transforms for those other facilities as true.

An example of a domain variable that specifies the location, the time, and a variable identifier is the total cost variable from the Energy Domain once the computer program 106 reformats the total cost variable to be specific to facility 1 for a period of a month. Through the use of such EMML primitives 136, the computer program 106 provides customers with the capability of achieving operational scalability by drastically reducing the development life cycle to create and/or test a large number of Performance Indicators through the elimination of middlemen such as software vendors and hired experts during a greatly accelerated development process.

The frame 200 may be part of a larger display screen that includes fields for users to enter commands to make, edit, and store selections and transform text. The user interface 108 in FIG. 1 may output a display screen that includes the frame 200 in FIG. 2 in response to a search based on search criteria input via the user interface 108 in FIG. 1. For example, a system user may enter search criteria to request to review the frame 200, which corresponds to the selections and transform text previously entered.

Because the frame 200 in FIG. 2 is a sample, the frame 200 could vary greatly in appearance. For example, the relative sizes and positioning of the columns and rows is not important to the practice of the present disclosure. The frame 200 can be depicted by any visual display, but is preferably depicted by a computer screen. The frame could also be output as a report and printed or saved in electronic format, such as portable document file (PDF). The frame 200 can be part of a personal computer system and/or a network, and operated from system data received locally, by the network, and/or on the Internet. The frame 200 may be navigable by a user. Typically, a user can employ a touch screen input or a mouse input device to point-and-click to a location on the frame 200 to manage the text on the frame 200, such as a selection that enables a user to drag the text from at least some of the columns 202-212 and drop the text into the reformatted variables column 214. Alternately, a user can employ directional indicators, or other input devices such as a keyboard. The text depicted by the frame 200 is an example, as the frame 200 may include a much greater amount of text.

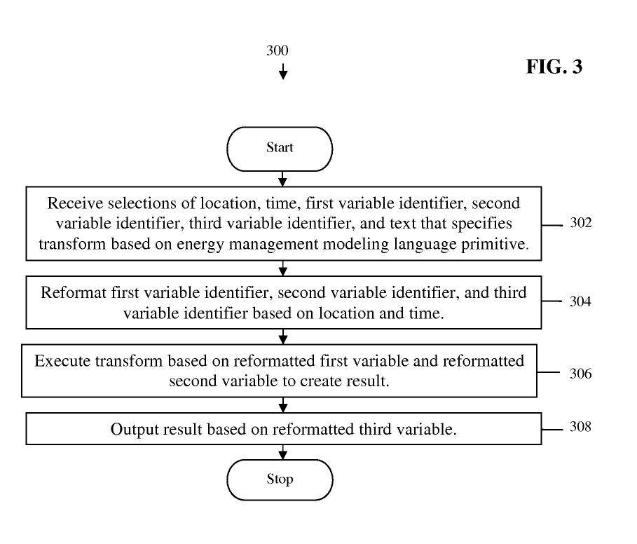

FIG. 3 presents a sample method 300 of the present disclosure. The energy management system 100 in FIG. 1 may execute the method 300 to receive selections of variables and energy management modeling language primitives, and output results based on applying energy management modeling language primitives to the selected variables.

In box 302, selections of a location, a time, a first variable identifier, a second variable identifier, a third variable identifier, and a text that specifies a transform based on an energy management modeling language primitive are received. For example, the computer program 106 receives selections of facility 1, a monthly time period, a thermostat, a total cost, a budget, and the text in the transform text for reformatted variables column 216 in FIG. 2.

In box 304, a first variable identifier, a second variable identifier, and a third variable identifier are reformatted based on a location and a time. For example, the computer program 106 reformats any data for the thermostat as monthly data for the thermostat in the basement of facility 1, the total cost as the monthly total cost for facility 1, and the budget as the monthly budget for facility 1.

In box 306, a transform is executed based on a reformatted first variable and a reformatted second variable to create a result. For example, the computer program 106 executes the transforms depicted in the reformatted variables column 216 in FIG. 2 based on the monthly total cost for facility 1 and the monthly budget for facility 1.

In box 308, a result is output based on a reformatted third variable. For example, the computer program 106 outputs a control command to initiate a conservation policy to the thermostat in the basement of facility 1 because the total monthly cost for facility 1 exceeds 90% of the monthly budget for facility 1.

The method 300 may be repeated as desired. Although this disclosure describes the boxes 302-308 executing in a particular order, the boxes 302-308 may be executed in a different order.

The systems, methods, and computer program products in the embodiments described above are exemplary. Therefore, many details are neither shown nor described. Even though numerous characteristics of the embodiments of the present disclosure have been set forth in the foregoing description, together with details of the structure and function of the present disclosure, the present disclosure is illustrative, such that changes may be made in the detail, especially in matters of shape, size and arrangement of the components within the principles of the present disclosure to the full extent indicated by the broad general meaning of the terms used in the attached claims. The description and drawings of the specific examples above do not point out what an infringement of this patent would be, but are to provide at least one explanation of how to make and use the present disclosure. The limits of the embodiments of the present disclosure and the bounds of the patent protection are measured by and defined in the following claims.

1. A system for an energy management modeling language, the system including:
a computer;
a memory;
a user interface; and
a computer program stored in the memory and executable by the computer to:
receive, via the user interface, selections of a location, a time, a first variable identifier, a second variable identifier, a third variable identifier, and text that specifies a transform based on an energy management modeling language primitive;
reformat the first variable identifier, the second variable identifier, and the third variable identifier based on the location and the time;
execute the transform based on the reformatted first variable and the reformatted second variable to create a result; and
output the result based on the reformatted third variable.

2. A system as in claim 1, wherein the computer program includes a list of locations defined within an asset structure tree, a list of transforms, and schedules associated with the list of transforms.

3. A system as in claim 1, wherein the computer program is further executable to input a variable associated with the location from a database and input any transform associated with the variable.

4. A system as in claim 1, wherein the computer program is further executable to parse a transform to build an abstract syntax tree.

5. A system as in claim 1, wherein the computer program is further executable to use an abstract syntax tree to build an execution tree and apply the transform to a variable by executing the execution tree.

6. A system as in claim 1, wherein the energy management modeling language primitive includes an organizational asset tree that groups facility assets into at least one set.

7. A system as in claim 1, wherein the energy management modeling language primitive includes an aggregate primitive that accumulates data over a period of time.

8. A system as in claim 1, wherein the energy management modeling language primitive includes a billing primitive that includes at least one of a time of use period, a peak demand, a usage cost, a billable demand, and a demand cost.

9. A system as in claim 1, wherein the energy management modeling language primitive includes a persistence primitive that stores a variable for subsequent use by another transform.

10. A system as in claim 1, wherein the energy management modeling language primitive includes a domain variable that specifies the location, the time, and a variable identifier.

11. A system as in claim 1, wherein the transform is also based on at least one generic primitive that includes at least one of a variable assignment, a mathematical operator, a mathematical operator precedence specifier, logical operator, and a flow control instruction.

12. A system as in claim 1, wherein the energy management modeling language primitive includes an action primitive to prescribe a function based on a transform, wherein the action primitive includes at least one of an alert, a log, and a control command.

13. A system as in claim 1, wherein the result includes at least one of a mathematical calculation and a control command.

14. A computer-implemented method for an energy management modeling language, the method including the steps of:
receiving, via a user interface by a computer program stored in a memory and executed by a computer, selections of a location, a time frame, and first, second and third variable identifiers associated with, respectively, first, second and third data domains, and text that specifies a transform based on an energy management modeling language primitive;
reformatting, by the computer program, the first, second and third variable identifiers based on the selected time frame;
executing, by the computer program, the transform based on the reformatted first and second variable identifiers to create a result; and
outputting, by the computer program, the result to modify a state of a system measured by the reformatted third variable.

15. A computer-implemented method as in claim 14, wherein executing the transform is also based on at least one of a scheduled run time and a previous run time; and wherein outputting the result includes persisting the result as a global variable.

16. A computer-implemented method as in claim 14, wherein the first domain is a business domain which includes data associated with at least one of a budget, an energy consumption goal, a sales transaction, an operational expense, an energy cost, a demand cost, and a transaction energy cost.

17. A computer-implemented method as in claim 13, wherein the second domain is an energy domain which includes data for at least one of real usage, reactive usage, power factor, maximum demand, kilovolt-ampere reactive (kVAr), kilovolt-ampere reactive hours (kVArh), power factor, kilowatts during a base time of use, kilowatts during an intermediate time of use, kilowatts during a sub-peak time of use, kilowatts during a peak time of use, kilowatt hours during a base time of use, kilowatt hours during an intermediate time of use, kilowatt-hours during a sub-peak time of use, and kilowatt hours during a peak time of use.

18. A computer-implemented method as in claim 13, wherein the third domain is a facility domain which includes data that is associated with at least one of a meter, a meter configuration, real-time data, a sampling frequency, heating ventilation and air conditioning (HVAC), lighting, humidity, and temperature.

19. A computer program product for an energy management modeling language, the computer program product including:
a computer readable storage medium storing computer executable program code that, when executed by a processor, causes the computer executable program code to perform a method including the steps of:
receiving, via a user interface, selections of a location, a time, a filter, a first variable identifier based on the location and associated with a first domain of data, a second variable identifier based on the location and associated with a second domain of data, a third variable identifier based on the location and associated with a third domain of data, and text that specifies a transform based on an energy management modeling language primitive, wherein the first domain of data, the second domain of data, and the third domain of data are mutually exclusive domains of data;
reformatting the first variable identifier, the second variable identifier, and the third variable identifier based on the time and the filter;
executing the transform based on the reformatted first variable and the reformatted second variable to create a result; and
outputting the result based on the reformatted third variable.

20. A computer program product as in claim 19, wherein the filter includes at least one of a nighttime filter, a daytime filter, a during business hours filter, an outside business hours filter, a weekday filter, and a weekend filter.
